(19) United States
(12) Patent Application Publication
(10) Pub. No.: US 2005/0238574 A1
(43) Pub. Date: Oct. 27, 2005

(54) High performance water gas shift catalyst and a method of preparing the same

(75) Inventors: Dong Ju Moon, Seoul (KR); Jong Woo Ryu, Seoul (KR); Dae Hyun Kim, Seoul (KR); Sang Deuk Lee, Seoul (KR); Byung Gwon Lee, Seoul (KR)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KOREA INSTITUTE OF SCIENCE AND TECHNOLOGY

(21) Appl. No.: 10/852,452

(22) Filed: May 25, 2004

(30) Foreign Application Priority Data
Apr. 26, 2004 (KR) 2004-28765

(51) Int. Cl. C01B 3/26

(52) U.S. Cl. 423/652; 502/304

(57) ABSTRACT

The present invention relates to a high performance water gas shift catalyst and a method of preparing the same, more particularly to a high performance water gas shift catalyst comprising active components such as copper (Cu), nickel (Ni) and platinum (Pt) and a ceria (CeO₂) support, which has better catalytic activity and thermal cycling durability with minimum platinum supporting amount of 1 wt % or less compared with the conventional Pt/CeO₂ catalyst and LTS catalyst, and a method of preparing the same.

### BACKGROUND OF THE INVENTION

1. Field of the Invention

The present invention relates to a high performance water gas shift catalyst and a method of preparing the same, more particularly to a high performance water gas shift catalyst comprising active components such as copper (Cu), nickel (Ni) and platinum (Pt) and a ceria (CeO₂) support, which has better catalytic activity and thermal cycling durability with minimum platinum supporting amount of 1 wt % or less compared with the conventional 5 wt %-Pt/CeO₂ catalyst and LTS catalyst, and a method of preparing the same.

2. Description of the Related Art

Carbon monoxide (CO) is generated during a fossil fuel reforming process. Because the carbon monoxide poisons platinum, which is used as fuel electrode catalyst of a polymer electrolyte membrane fuel cell (PEMFC) thus significantly reducing the performance of the fuel cell, it is essential to remove carbon monoxide before supplying reforming gas to the PEMFC stack. Considering the effect on the long-term performance of the PEMFC stack, the carbon monoxide content allowed in the reforming gas is recommended to be less than about 20 ppm, preferably less than 10 ppm.

Such methods as water gas shift (WGS) reaction, preferential partial oxidation (PROX) and methanation have been reported as techniques to remove carbon monoxide from the reforming gas. The method of connecting a WGS reactor and a PROX reactor in sequence is most typical for a fuel reformer integrated with a PEMFC system. The WGS reactor reduces the carbon monoxide content of the reforming gas to about 1%, thereby reducing the burden of the PROX reactor and increasing the hydrogen content. The PROX reactor selectively oxidizes the carbon monoxide exiting the WGS reactor, thereby reducing the CO content of the reforming gas to less than about 10 ppm.

In the water gas shift reaction, carbon monoxide reacts with water vapor to produce hydrogen and carbon dioxide, as shown in the following Scheme 1.
CO+H₂O→CO₂+H₂ ΔH=−40.5 kj/mol Scheme 1

The conversion of the water gas shift is determined by temperature and pressure under the control of equilibrium conversion. Since the water gas shift of Scheme 1 is exothermic, it is advantageous to be proceeded at low temperature.

The water gas shift may be proceeded with by two steps of high temperature water gas shift (HTS) and low temperature water gas shift (LTS), if necessary, to reduce the carbon monoxide content. In the general commercial process, the HTS reactor is operated at around 300 to 450° C., and the LTS reactor at 200 to 300° C.

With the recent increasing demand for hydrogen from many industrial fields, hydrogen production by water gas shift has been drawing much attention. Especially, the WGS reaction is regarded as an important reaction process in the industries producing a variety of compounds using hydrogen, ammonia and syngases. Generally, hydrogen (H₂) is produced along with a lot of carbon monoxide during steam reforming (SR), partial oxidation (POₓ) or autothermal reforming (ATR) of hydrocarbons. The carbon monoxide as a byproduct negatively affects various chemical reactions. For example, it poisons the catalyst used in ammonia synthesis during ammonia synthesis process and the platinum (Pt) based cathode catalyst of a polymer electrolyte membrane fuel cell. Accordingly, the WGS reaction, which reduces the carbon monoxide and enhances hydrogen production, is considered as an essential chemical process [D. S. Newsome, Catal. Rev.—Sci. Eng., 21(2), (1980) 275].

For reactions related with the water gas shift reaction, there are high temperature water gas shift (HTS) reaction, low temperature water gas shift (LTS) reaction and sour gas shift (STS) reaction. The sour gas shift is a process of reacting sulfur-containing charcoal or raw gas produced by gasification with water vapor at around 350° C. to convert it into liquid fuel. For the conventional HTS catalyst, Fe₃O₄ containing 8 to 12 wt % of Cr₂O₃ is used. Here, Cr₂O₃ prevents sintering of Fe₃O₄ at high temperature, thereby preventing a concomitant loss of surface area. MgO or ZnO may be added to the HTS catalyst to improve methane productivity, resistance to sulfur or mechanical strength [A. Andreev et al., Applied Catalysis, 22 (1985)

For the conventional LTS catalyst, Cu/Zn based catalyst is most prevalent. It is prepared from metal nitrate, Cu/Zn ratio of which normally ranging from 0.4 to 2, and sodium carbonate solution by coprecpitation [Yeping Cai et al., U.S. Pat. No. 6,627,572 B1 (2003); G. Petrini et al., Studies in Surface Science and Catalysis, 16 (1983) 735]. In the industries, Cu/ZnO/Al₂O₃ based oxide catalyst is the most prevalent. The LTS catalyst developed by ICI (ICI-52-1) comprises CuO of 30 wt %, ZnO of 45 wt % and Al₂O₃ of 13 wt % [G. W. Bridger et al., Catalyst Handbook, ICI, Wolf Scientific Books, (1970) 97]. In the sour gas shift of converting sulfur-containing charcoal (mainly lignite) into liquid fuel, it is desirable to use Mo based catalyst, which is resistant to sulfur. The Mo based catalyst is prepared by impregnating ammonium heptamolybdate ((NH₄)₆Mo₇O₂₄. 4H₂O) solution to a support such as Al₂O₃, MgO, ZnO, Mg-aluminate or Zn-aluminate, drying it and calcining it at 500° C. [X. Xie et al., Applied Catalysis, 77 (1991) 187].

Researches on the development of high performance WGS catalyst have been carried out consistently since the 1960s. As commercialization of fuel cell-powered vehicles draw near, a variety of WGS catalysts are being reported. Recently, Akira Igarashi et al. presented a platinum based WGS catalyst in which platinum is supported on an alumina or zirconia support and reported that the WGS reaction yield is enhanced when metals such as rhodium, yttrium, calcium, chromium, lanthanum and ruthenium are added in addition to 3 wt % of platinum [Korea Patent No. 386,435]. Also, catalysts in which Pt, Pd, Cu and Ni are supported on CeO₂ show excellent WGS reaction activity, and thus draw attentions [R. J. Gorte et al., Applied Catalysis A: General 258 (2004) 271; Samuel J. Tauster, et al., U.S. Pat. No. 5,139,992 (1992)]. The excellent WGS reaction activity rendered on the metal catalyst supported on ceria (CeO₂) is due to the high oxygen storage capacity and oxygen mobility of ceria. Gorte et al. reported that carbon monoxide adsorbed on the metal surface of the catalyst reacts with lattice oxygen or oxygen adsorbed on ceria surface during the WGS reaction. They concluded that the superior activity is due to the good oxygen storage capacity and oxygen mobility of ceria. U.S. Pat. No. 0,195,115 A1 discloses a precious metal supported WGS catalyst in which a precious metal selected form Pt, Rh, Ru and Re is supported on titania or zirconia. However, the precious metal supported WGS catalyst is expensive and therefore limited in availability. Thus, the development of high performance transition metal based WGS catalyst is required. Especially, because the price of platinum based catalyst is accounted for about 20% of the cost for the entire reforming system in the conventional fuel reformer, high cost and restriction on availability of platinum give negative influences on its commercialization.

According to a report by DOE of the U.S., in case the conventional HTS and LTS catalysts are used, the WGS reactor takes only one third of a fuel reformer in volume, weight and cost. Therefore, miniaturization is a key technique in the commercialization of a fuel reformer for fuel cell-powered vehicles applications. The activity of the conventional Cu/ZnO/Al₂O₃ based LTS catalyst varies largely in oxidation and reduction atmosphere. At a relatively high temperature of 250° C. or greater, the catalyst tends to be easily sintered and shows a poor resistance to sulfur [D. J. Moon, J. W. Ryu, Catal. Letters 92 (1-2) (2004) 17]. Accordingly, it is important to develop high performance WGS catalyst capable of replacing the conventional LTS catalyst, which has good durability even under the thermal cycling condition where oxidation and reduction states are reiterated, and has good resistance to sulfur and improved catalytic activity compared to those of LTS catalyst. Recently, the present inventors developed a transition metal carbide based WGS catalyst that can replace the conventional LTS catalyst, which has good durability under the thermal cycling condition. Thus developed WGS catalyst was confirmed to have improved thermal cycling durability [D. J. Moon, J. W. Ryu, Catalysis Letters 92 (1-2) (2004) 17; L. T. Thompson, J. Patt, D. J. Moon, C. Phillips, U.S. Pat. No. 6,623,720 B2].

### SUMMARY OF THE INVENTION

The present inventors have consistently conducted numerous researches to develop novel catalysts for high performance water gas shift reaction. As a result, they have found that a catalyst prepared by supporting active components such as nickel (Ni) and copper (Cu) on a ceria (CeO₂) support and supporting less than 1 wt % of platinum (Pt) as promoter has good catalytic activity and superior thermal cycling durability and is capable of reducing the size of a WGS reactor, thus showing that it can be used as a fuel reformer catalyst for fuel cell-powered vehicles applications.

Therefore, it is an object of the present invention to provide a high performance water gas shift catalyst capable of replacing the conventional LTS catalyst, and a method of preparing the same.

It is another object of the present invention to provide a use of applying the catalyst of the present invention to the water gas shift process, in which carbon monoxide is reacted with water vapor to be converted to hydrogen and carbon dioxide.

### BRIEF DESCRIPTION OF THE DRAWINGS

FIG. 1 is a graph comparing CO conversions of the conventional LTS catalyst and the catalyst of the present invention when water gas shift was performed at 200 to 300° C. using a syngas comprising H₂ of 62.5%, H₂O of 31.8% and CO of 6.7%.

FIG. 2 is a graph comparing CO conversions of the conventional LTS catalyst and the catalyst of the present invention when thermal cycling was performed at 250° C. for 130 hours turning on and off the power switch of a water gas shift reactor.

### DETAILED DESCRIPTION OF THE PREFERRED EMBODIMENTS

The present invention relates to a water gas shift catalyst in which nickel (Ni) alone or nickel (Ni) and copper (Cu) are supported on a ceria (CeO₂) support as major active component and 1 wt % (of the ceria support weight) or less of platinum (Pt) is supported as minor active component.

Hereinafter, the present invention is described in more detail.

The present invention relates to a novel catalyst for water gas shift (WGS) reaction, which converts carbon monoxide (CO) contained in hydrocarbons or syngas generated during reforming of liquid fuel into highly pure hydrogen, a preparing method thereof and a use thereof. The novel catalyst of the present invention is a useful WGS catalyst that can replace the conventional LTS catalyst. Especially, because it has superior thermal cycling durability, it becomes a useful fuel reformer catalyst for fuel cell-powered vehicles applications.

The catalyst of the present invention is a water gas shift catalyst prepared by supporting nickel (Ni) alone or nickel (Ni) and copper (Cu) on a ceria (CeO₂) support as major active metal components and supporting a small amount of platinum (Pt) as minor active component to enhance activity and thermal cycling durability of the catalyst.

The copper (Cu), nickel (Ni) and platinum (Pt) as active metal components are supported on a ceria (CeO₂) in the form of precursor compounds. The metal precursors may be prepared in the forms of oxides, chlorides or nitrates as in the preparation of the conventional catalyst. Contents of the active metal components are as follows. Copper is supported from 0 to 10 wt %, preferably from 1.0 to 5 wt %, based on the weight of ceria support. If the copper supporting content exceeds 10 wt %, thermal cycling durability may deteriorate due to sintering of copper particles. Nickel is supported from 20 to 70 wt %, preferably from 30 to 65 wt %, based on the ceria support weight. If the nickel supporting content is below 20 wt %, catalytic activity may deteriorate. In contrast, if it exceeds 70 wt %, catalytic activity may deteriorate due to facilitated sintering of the metal. Platinum is supported from 0.2 to 1 wt %, preferably from 0.2 to 0.5 wt %, based on the ceria support weight. If the platinum supporting content is below 0.2 wt %, thermal cycling durability is not good. In contrast, if it exceeds 1 wt %, the catalytic activity is improved but the catalyst becomes too expensive.

The preparing method of the present invention comprises the steps of: 1) preparing each active metal salt solution by dissolving precursors of copper (Cu), nickel (Ni) and platinum (Pt); 2) preparing the ceria slurry after treatment of the ceria in air; 3) impregnating the active metal salt solution on the ceria slurry; 4) drying the catalyst precursors; and 5) calcining the dried catalyst precursor in air.

Each of steps involved in the preparing method of the present invention is described in more detail.

In the first step, each metal salt solution containing each active metal is prepared. That is, each metal salt solution is prepared by dissolving each precursor compound of copper, nickel and platinum in ultrapure water at 20 to 60° C. For the metal precursor compound, oxide, chloride or nitrate is used as in preparation of the conventional catalyst. More preferably, copper and nickel are used in the form of nitrate or chloride and platinum is used in the form of chloride.

In the second step, ceria is pre-treated in air and made to a slurry. In the WGS reaction, carbon monoxide adsorbed on the metal surface of the catalyst reacts with lattice oxygen or oxygen adsorbed on the surface of the ceria. Because ceria has large oxygen storage capacity, it enables to retain oxygen very well. Also, the large oxygen mobility offers good activity and enhances dispersion of metal in the supported metal catalyst. Therefore, it is apparent that ceria has optimum conditions as a support for a WGS reaction. Further, it is preferable to pre-treat ceria to remove impurities and offer a larger surface area. Therefore, ceria is calcined in air of 500 to 900° C. for 2 to 4 hours and made to a slurry.

In the third step, the active metal salt solution is impregnated on the ceria slurry to prepare a catalyst precursor. Each metal salt solution is added to the support slurry dropwise at 50 to 70° C. while stirring. Then, the mixture is stirred at 70 to 90° C. for 3 to 6 hours to impregnate the active metal on the support.

In the fourth step, the impregnated catalyst precursor is completely dried in a drying oven of 100 to 120° C. for 12 to 24 hours.

In the last step, the dried catalyst precursor is heated from room temperature to 450 to 650° C. in air at a rate of 5 to 10° C./min, and calcined in air for 2 to 4 hours to prepare the water gas shift catalyst of the present invention.

Such prepared catalyst of the present invention is characterized in that the supporting content of precious metal, i.e. platinum, is minimized. In spite of the minimized platinum supporting content, the catalyst has sufficiently high catalytic activity for water gas shift reaction. Moreover, it has superior thermal cycling durability and is expected to offer improved resistance to sulfur. Accordingly, the catalyst of the present invention becomes a useful water gas shift catalyst.

The present invention includes a water gas shift process using the catalyst of the present invention. The catalyst of the present invention has been confirmed to have high catalytic activity and superior thermal cycling durability when applied to a water gas shift process under the reaction temperature of 200 to 350° C. and space velocity of 1,000 to 50,000 h⁻¹. Accordingly, the catalyst of the present invention becomes a useful catalyst for a water gas shift process to reduce the content of carbon monoxide in the hydrogen-rich gases.

The water gas shift may be applied to a fuel reformer for fuel cell-powered vehicles applications, fuel reformers for polymer electrolyte membrane fuel cells (PEMFCs), hydrogen station and petrochemical processes. Hydrogen-rich gases hich is used as a raw material of the water gas shift process of the present invention, is a gas synthesized from reforming of hydrocarbons. To be specific, the syngas may be derived from: liquid fuels such as naphtha, gasoline, and diesel; gaseous fuels such as liquefied natural gas (LNG), liquefied petroleum gas (LPG), methane, ethane, propane and butane; or solid fuels.

### EXAMPLES

Hereinafter, the present invention is described in more detail through Examples. However, the following Examples are only for the understanding of the present invention, and the present invention is not limited by the following Examples.

Catalyst Preparation Example: Preparation of Water Gas Shift (WGS) Catalyst

Copper nitrate (Cu(NO₃)₂.xH₂O, 99.99%, Sigma-Aldrich Chemicals), nickel nitrate ((Ni(NO₃)₃.6H₂O, 99.9%, Sigma-Aldrich Chemicals), chloroplatinic acid (H₂PtCl₆.xH₂O, 99%, High Purity Chemicals) and CeO₂ powder (99.9%, Sigma-Aldrich Chemicals) were used as precursors to prepare a catalyst.

First, a predetermined amount of each copper nitrate, nickel nitrate and chloroplatinic acid was dissolved in ultrapure water of 60° C. to prepare each metal salt solution. Then, ceria was pre-treated in air at 900° C. for about 2 hours and made to a slurry of 60° C. The prepared metal salt solution was added dropwise and strongly stirred at 80° C. for 4 hours to impregnate it. The slurry was completely dried in a drying oven of 110° C. for 12 hours. The dried catalyst precursor was heated at room temperature to 550° C. at a rate of 5 to 10° C./min in air, and then calcined for 4 hours to prepare a catalyst.

Catalysts were prepared by varying contents of Pt, Cu and Ni as in the following Table 1:

TABLE 1

| | | Catalyst composition | | | |
|---|---|---|---|---|---|
| | | (by weight) | | | |
| Catalysts | | Pt | Cu | Ni | CeO₂ |
| Catalyst-A | 5 wt % Pt/CeO₂ | 5 | — | — | 100 |
| Catalyst-B | 65 wt % Ni/CeO₂ | — | — | 65 | 100 |
| Catalyst-C | 1 wt % Pt—65 wt % Ni/CeO₂ | 1 | — | 65 | 100 |
| Catalyst-D | 0.5 wt % Pt—65 wt % Ni/CeO₂ | 0.5 | — | 65 | 100 |
| Catalyst-E | 0.4 wt % Pt—65 wt % Ni/CeO₂ | 0.4 | — | 65 | 100 |
| Catalyst-F | 0.2 wt % Pt—65 wt % Ni/CeO₂ | 0.2 | — | 65 | 100 |
| Catalyst-G | 0.4 wt % Pt—3 wt % Cu—62 wt % | 0.4 | 3 | 62 | 100 |
| | Ni/CeO₂ | | | | |
| Catalyst-H | 0.4 wt % Pt—5 wt % Cu—60 wt % | 0.4 | 5 | 60 | 100 |
| | Ni/CeO₂ | | | | |

Characteristics of the prepared catalysts were measured with the typical fixed bed catalyst reaction system comprising a reactant feeder, an evaporator, a WGS reactor, a water trap and an on-line gas chromatograph (GC) [D. J. Moon, J. W. Ryu, Catalysis Letters 92 (1-2) (2004) 17]. Gaseous reactants such as hydrogen, carbon monoxide and nitrogen were fed to the reactor using a mass flow controller according to the pre-treatment and reaction conditions. Liquid reactants such as water were fed to the evaporator using a metering pump (Young Lin Co., model M930), preheated to 350° C. there, and then fed to the reactor. For the evaporator and the WGS reactor, ½-inch tubes made of Inconel-600 were used. Reaction temperature was measured at both the inlet and the outlet of the catalyst layer using chromel-alumel thermocouples installed at the inlet and outlet, respectively. The reaction temperature was controlled within ±1° C. using a PID temperature controller. All lines were heated to 120° C. or over, so that moisture included in the reaction product is not condensed. Temperature of each line was detected with a thermocouple and recorded by a temperature recorder. As the optimum WGS reaction condition, the one recently reported by the present inventors was used [D. J. Moon, J. W. Ryu, Catalysis Letters 92 (1-2) (2004) 17].

### Example 1

Water gas shift of hydrogen-rich mixture gas 62.5% H₂, 31.8% H₂O and 5.7% CO) was performed under the following condition.

0.5 g of Catalyst-A presented in Table 1 was charged in the catalyst layer of a fixed bed reactor supported with quartz wool. Then, reduction was performed for 1 hour at 500° C. while flowing an Ar mixture gas containing hydrogen of 5% at a rate of 40 cc/min. WGS reaction was performed at the reaction temperature of 200, 220, 240, 260, 280 and 300° C., respectively. CO conversion at each reaction temperature is shown in Table 2.

Moisture included in the reaction product was removed by the water trap. Analysis was performed using an on-line gas chromatograph (Hewlett Packard Co., HP5890 series II) equipped with a carbosphere column (3.18×10⁻³ m O.D. and 2.5 m length) and a thermal conductivity detector (TCD).

### Examples 2 to 8

WGS reaction was performed as in Example 1, except for using Catalysts-B, C, D, E, F, G and H instead of Catalyst-A. CO conversion at each reaction temperature is shown in Table 2.

TABLE 2

| | | CO conversion (%) at each | | | | | |
|---|---|---|---|---|---|---|---|
| | | reaction temperature (° C.) | | | | | |
| Classifi- | | 220° | 220° | 240° | | | |
| cation | Catalysts | C. | C. | C. | 260° C. | 280° C. | 300° C. |
| Example 1 | Catalyst-A | 50.1 | 53.2 | 62.5 | 81.0 | 89.6 | 90.4 |
| Example 2 | Catalyst-B | 45.1 | 46.8 | 52.8 | 57.4 | 70.6 | 87.9 |
| Example 3 | Catalyst-C | 45.8 | 46.1 | 54.3 | 69.8 | 88.2 | 87.5 |
| Example 4 | Catalyst-D | 52.1 | 54.2 | 62.9 | 87.9 | 87.9 | 86.7 |
| Example 5 | Catalyst-E | 52.3 | 55.0 | 64.1 | 81.5 | 86.7 | 88.0 |
| Example 6 | Catalyst-F | 48.3 | 52.7 | 59.4 | 67.4 | 78.7 | 78.5 |
| Example 7 | Catalyst-G | 54.0 | 58.5 | 69.0 | 83.0 | 90.5 | 90.7 |
| Example 8 | Catalyst-H | 52.3 | 57.4 | 67.9 | 81.1 | 88.7 | 88.9 |

### Example 9

To confirm the thermal cycling durability of the catalyst, water gas shift of hydrogen-rich mixture gas (62.5% H₂, 31.8% H₂O and 5.7% CO) was performed under the following condition.

0.5 g of Catalyst-A was charged in the catalyst layer of a fixed bed reactor supported with quartz wool. Then, pre-treatment was performed at 400° C. for 1 hour while flowing an Ar mixture gas containing hydrogen of 5% at a rate of 40 cc/min. CO conversion was measured at 250° C. for 130 hours turning on and off the LTS reactor every 6 to 12 hours. Change of CO conversion with time is shown in Table 3.

Moisture included in the reaction product was removed by the water trap. Analysis was performed using an on-line gas chromatograph (Hewlett Packard Co., HP5890 series II) equipped with a carbosphere column (3.18×10⁻³ m O.D. and 2.5 m length) and a thermal conductivity detector (TCD).

### Examples 10 to 13

Thermal cycling was performed as in Example 9 except for using Catalysts-B, E and G instead of Catalyst-A. Change of CO conversion with time is shown in Table 3.

TABLE 3

| | | CO conversion (%) with reaction time (hr) | | | | | |
|---|---|---|---|---|---|---|---|
| Classification | Catalysts | 20 hr | 40 hr | 60 hr | 80 hr | l00 hr | l20 hr |
| Example 10 | Catalyst-A | 69.1 | 68.9 | 68.7 | 68.5 | 68.0 | 67.5 |
| Example 11 | Catalyst-B | 55.6 | 55.3 | 53.9 | 51.4 | 48.4 | 46.5 |
| Example 12 | Catalyst-E | 66.2 | 66.4 | 65.4 | 62.8 | 62.0 | 60.4 |
| Example 13 | Catalyst-G | 72.5 | 72.0 | 71.3 | 70.9 | 70.3 | 69.8 |

### Comparative Example 1

WGS reaction was performed as in Example 1, except for reducing at 200° C. for 4.5 hours under the flow of a mixture gas comprising 2% of H₂ and N₂ using the conventional LTS catalyst (Cu—ZnO/Al₂O₃) instead of Catalyst-A (5wt % Pt/CeO₂).

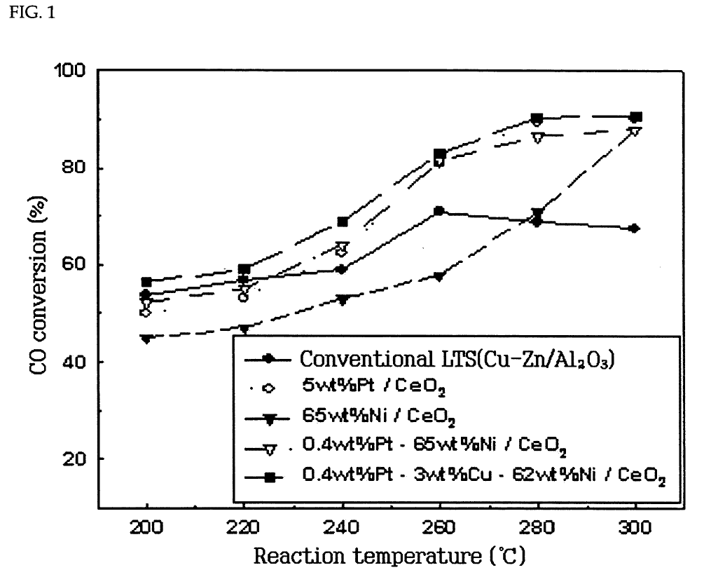

FIG. 1 compares CO conversions of the catalysts of the present invention and the conventional Cu—ZnO/Al₂O₃ catalyst at a variety of reaction temperatures. The catalyst of the present invention showed a higher carbon monoxide conversion at 250° C. or higher than the conventional LTS catalyst (Cu—ZnO/Al₂O₃). The catalytic activity increased as the reaction temperature increased. Particularly, the Pt—Ni/CeO₂ based catalyst (Catalysts-C, D, E and F) and the Pt—Cu—Ni/CeO₂ catalyst (Catalyst-G and H) showed higher CO conversion in the reaction temperature range of 200 to 280° C. than Catalyst-A (5 wt % Pt/CeO₂) in spite of low platinum supporting content (less than 1 wt %). On the other hand, although the conventional Cu—ZnO/Al₂O₃ catalyst showed relatively high catalytic activity in the temperature range of 250 to 260° C., the CO conversion decreased as the reaction temperature increased.

### Comparative Example 2

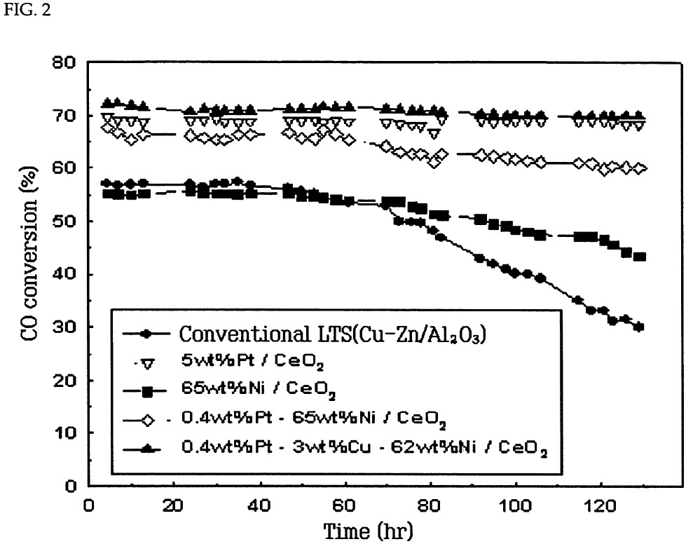

Thermal cycling was performed as in Example 9, except for reducing at 200° C. for 4.5 hours under the flow of a mixture gas comprising 2% of H₂ and N₂ using the conventional LTS catalyst (Cu—ZnO/Al₂O₃) instead of Catalyst-A (5 wt % Pt/CeO₂). FIG. 2 compares CO conversions of the catalysts of the present invention and the conventional Cu—ZnO/Al₂O₃ catalyst at a variety of reaction time.

No catalyst showed perfect thermal cycling durability. Catalyst-A (5 wt % Pt/CeO₂) showed the best durability. Although Catalyst-E (0.4 wt % Pt-65 wt % Ni/CeO₂) and Catalyst-G (0.4 wt % Pt-3 wt % Cu-62 wt % Ni/CeO₂) showed slightly worse durability than Catalyst-A, they were much superior in durability than the conventional LTS catalyst.

BET surface area, pore size and active metal surface area of the catalyst before and after thermal cycling were measured for nitrogen physical adsorption and CO chemical adsorption using a Quantachrome adsorption analyzer (Autosorb-1C). After thermal cycling, BET surface area, pore size and active metal surface area of the conventional LTS catalyst decreased by 30%, 14% and 19%, respectively. However, BET surface area, pore size and active metal surface area of Catalyst-G (0.4 wt % Pt-3 wt % Cu-62 wt % Ni/CeO₂) were decreased by 12%, 9% and 4%, respectively. This shows that the catalyst of the present invention has better thermal cycling durability than the conventional LTS catalyst.

Deactivation of the Cu—ZnO/Al₂O₃ catalyst during thermal cycling seems to be due to coking and sintering. It was confirmed by XRD, SEM and TEM analyses [D. J. Moon, J. W. Ryu, Catalysis Letters 92 (1-2) (2004) 17]. Because the catalyst of the present invention has high water gas shift activity and superior thermal cycling durability, it can be used as WGS catalyst of a fuel reformer for fuel cell-powered vehicles applications, replacing the conventional LTS catalyst.

Although the catalyst of the present invention has a minimum platinum supporting content of 1 wt % or less, it offers better catalytic activity in the temperature range of 200 to 280° C. than Catalyst-A, platinum supporting content of which being 5 wt %, and the conventional LTS (Cu—ZnO/Al₂O₃) based catalyst. Also, the catalyst of the present invention shows much better catalytic activity at 280° C. or higher than the conventional LTS catalyst, and better catalytic activity than Catalyst-A. In addition, the catalyst of the present invention shows much better thermal cycling durability than the conventional LTS catalyst at 250° C., and comparable durability to Catalyst-A. Moreover, the catalyst of the present invention is expected to be resistant to sulfur during water gas shift because platinum-containing catalysts are known to be resistant to sulfur. Accordingly, the catalyst of the present invention will be useful in water gas shift processes of reforming gases produced from reforming of sulfur-containing liquid fuels.

1. A water gas shift catalyst wherein nickel (Ni) alone or nickel (Ni) and copper (Cu) are supported together on a ceria (CeO₂) support as major active component, and 1 wt % or less of platinum (Pt) is supported as minor active component based on the weight of said ceria support.

2. The catalyst of claim 1 wherein copper is supported from 0 to 10 wt % based on the weight of said ceria support.

3. The catalyst of claim 1 wherein nickel is supported from 20 to 70 wt % based on the weight of said ceria support.

4. The catalyst of claim 1 wherein platinum is supported from 0.2 to 1 wt % based on the weight of said ceria support.

5. A method of preparing a water gas shift catalyst comprising the steps of:
1) dissolving each precursor of copper, nickel and platinum in ultrapure water of 20 to 60° C. to prepare an active metal salt solution;
2) pre-treating ceria at 500 to 900° C. for 2 to 6 hours in air and making it to a slurry;
3) adding said active metal salt solution dropwise to the ceria slurry of 50 to 70° C. while stirring, and stirring it at 70 to 90° C. for 3 to 12 hours to impregnate Cu, Ni and Pt on said ceria support;
4) completely drying said impregnated catalyst precursor in a drying oven of 100 to 120° C. for 12 to 24 hours; and
5) heating said dried catalyst precursor at room temperature to 450 to 650° C. in air at a rate of 5 to 10° C./min and then calcining it for 2 to 4 hours.

6. A water gas shift process of converting carbon monoxide included in a hydrogen-rich gases into hydrogen, which is performed at 200 to 350° C. with spatial velocity of 1,000 to 50,000 h⁻¹ in the presence of a catalyst selected from claims 1 to 4.

7. The water gas shift process of claim 6, wherein said process comprises a fuel reforming process of fuel cell-powered vehicles applications, a fuel reforming process of a polymer electrolyte membrane fuel cell, a hydrogen station process or a petrochemical process.

8. The water gas shift process of claim 6, wherein said hydrogen-rich gases is a syngas obtained from reforming of: a liquid fuel such as naphtha, gasoline and diesel; a gaseous fuel such as liquefied natural gas, liquefied petroleum gas, methane, ethane, propane and butane; or a solid fuel.
